(19) United States
(12) Patent Application Publication
(10) Pub. No.: US 2006/0051272 A1
(43) Pub. Date: Mar. 9, 2006

(54) Catalytic converter for 2-cycle engines or small engines

(75) Inventors: Uwe Endruschat, Frankfurt (DE); Holger Lochmann, Waiblingen (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: W.C. Heraeus GmbH

(21) Appl. No.: 11/220,066

(22) Filed: Sep. 6, 2005

(30) Foreign Application Priority Data
Sep. 6, 2004 (DE) 10 2004 043 421.2

(51) Int. Cl. B01D 53/94

(52) U.S. Cl. 423/213.5; 502/325

(57) ABSTRACT

A catalytic converter is provided for 2-cycle stratified scavenging engines or engines with comparable exhaust-gas composition, the converter having a wash coat with an active phase containing one or more noble metals on a heat-resistant carrier. The portion of an oxygen storage component in the wash coat is less than about 10 wt. %.

### BACKGROUND OF THE INVENTION

The present invention relates to catalytic converters for engines operated in a rich-mixture range, especially 2-cycle stratified scavenging engines or engines with comparable exhaust-gas composition, which prevent scavenging fuel loss by stratification of an insulating air cushion.

Structurally, such a catalytic converter comprises a carrier and a wash coat. The carrier can be made of conventional carrier bodies that can be flowed through, for example ceramic or metallic materials or a honeycomb body. Honeycomb bodies are also designated as monoliths, as described, for example, in European published patent application EP 1 181 970 A1. Wash coats have structures, which are used for contacting the exhaust gas with the catalytic converter. Wash coats are made of carrier materials, for example the ceramic oxides listed in EP 1 181 970 A1. The carrier materials must be especially heat-resistant, especially for small engines.

These carrier materials are applied, for example to honeycomb bodies, as a ceramic coating comprising aluminum oxide, a component that stores oxygen, especially cerium oxide, and a noble metal, especially a phase containing platinum-group metals.

Typical catalytic converters for internal-combustion engines contain a mixture of aluminum oxide, cerium oxide, zirconium oxide, and lanthanum oxide with noble metals. Cerium oxide is a compound that stores oxygen. Instead of cerium oxide, other oxides of the lanthanum oxides can also be used as compounds that store oxygen, for example praseodymium oxide or neodymium oxide.

To clean the exhaust gases from fuel-conserving internal-combustion engines, according to European Patent EP 0 326 845, catalytic converters with improved lean-mixture activity are provided, in which, in addition to cerium oxide on the carrier, cerium is also included in the active phase of the noble metals.

Small engines are operated in a rich-mixture range, so that in parts of the exhaust gas, considerable amounts of unconsumed hydrocarbons are present. For small engines, German published patent application DE 197 36 628 A1 proposes a catalytic converter made of a non-noble metal for cleaning rich exhaust gases.

Constructions addressing this problem have been proposed, in which preventing overheating is an important viewpoint, for example according to German Patents DE 197 24 289 or DE 197 24 244.

According to U.S. Pat. No. 6,647,713, novel 2-cycle engines prevent high scavenging fuel losses by the stratification of an insulating air cushion. The exhaust-gas mixture of these engines is still to be characterized as rich. For these novel, so-called 2-cycle stratified scavenging engines, there are still no suitable catalytic converters.

According to German Patent DE 101 39 700, conventional catalytic converters are used for such engines. However, in the scope of the present invention, it was recognized that with these catalytic converters, the emission of hydrocarbons is not adequately reduced with regard to environmental pollution and future exhaust-gas standards. Instead, a characteristic of this type of engine is the characteristically high emission of unconsumed hydrocarbons, which can be viewed as the main cause for environmental pollution.

### BRIEF SUMMARY OF THE INVENTION

An object of the present invention is to provide effective catalytic converters for 2-cycle engines, which prevent scavenging fuel losses by stratification of an insulating air cushion. In particular, the emission load due to hydrocarbons should be effectively reduced by the catalytic converter.

To achieve this object, catalytic converters are provided, in which noble metals or noble metal mixtures are deposited on a high temperature-resistant carrier, wherein the catalytic converter, surprisingly, has no oxygen storage component. Surprisingly, typical oxygen storage components (OSC), such as cerium oxide, lead to degradation of the catalytic converting power in the new generation of 2-cycle engines. This degradation is small or negligible for a portion of an oxygen storage component of less than about 10 wt. % in the wash coat.

As the wash coat, a suitable material is high temperature-resistant aluminum oxide, such as the conventional material for typical catalytic converters for internal-combustion engines.

In principle, all active phases containing noble metal can be used on high temperature-resistant carriers, if no rare-earth metal oxide is present as an oxygen storage component, especially no cerium oxide. As active phases, noble metals and noble-metal alloys are suitable. Palladium or mixtures of palladium with other noble metals, especially with rhodium, have proven to be advantageous. Also, mixtures of alloys, in which palladium and especially with rhodium are contained as the essential component, are suitable as the active phase. Substantial amounts of noble metal components starting at about 0.1 wt. % or at least about 0.1% of the surface area portion in the wash coat, especially starting at about 10 wt. % or about 10% active surface area, are essential. Zirconium salts improve the effectiveness of the catalytic converter and are used preferably in a weight ratio of about 1:2 to 4:1 to the noble metals. Zirconium salts are generally converted into zirconium oxides, also designated as zirconium.

Despite their high quality, catalytic converters according to the invention can be manufactured easily and can be used favorably and for multiple purposes for 2-cycle engines. For the most part, they exhibit a constant activity for different exhaust-gas compositions (lambda variations). An enormously high selectivity of the HC conversion and a surprisingly reduced heat generation distinguish the catalytic converters according to the invention relative to conventional catalytic converters.

The catalytic converters are suitable for cleaning exhaust gas from 2-cycle engines, especially small 2-cycle engines, for example engines for chainsaws, power scythes, blowers, trimmers, hedge clippers, etc., which belong to the new generations of engines, whose scavenging fuel losses are minimized by the stratification of an insulating air cushion.

Surprisingly, it has been determined that the large percentages of cerium oxide on a wash coat lead to degradation of the exhaust-gas cleaning in these engines. The manufacture of catalytic converters according to the invention is performed without applying cerium oxide onto the wash coat.

Below a weight portion of about 10% of cerium oxide, especially at less than about 3%, the disturbance by cerium oxide loses significance. At smaller amounts of cerium oxide in the range of about 0.1% to 1%, the effect of the CeO₂ is negligible.

The catalytic converters according to the invention can be designed and structured analogously to those of EP 1 181 970 A1, if, in contrast to EP 1 181 970 A1, the portion of oxygen storage components in the wash coat is less than about 10 wt. %, preferably less than about 3 wt. %, and especially less than about 1 wt. %.

In preferred embodiments:
the wash coat is a high temperature-resistant doped aluminum oxide, especially doped with lanthanum, zirconium, or barium;
the active layer has significant portions of palladium or palladium mixtures with other noble metals, especially with rhodium; and/or
the active phase has noble-metal components and zirconium oxide, especially in a weight ratio of zirconium oxide to noble metal components of about 4:1 to 1:2.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

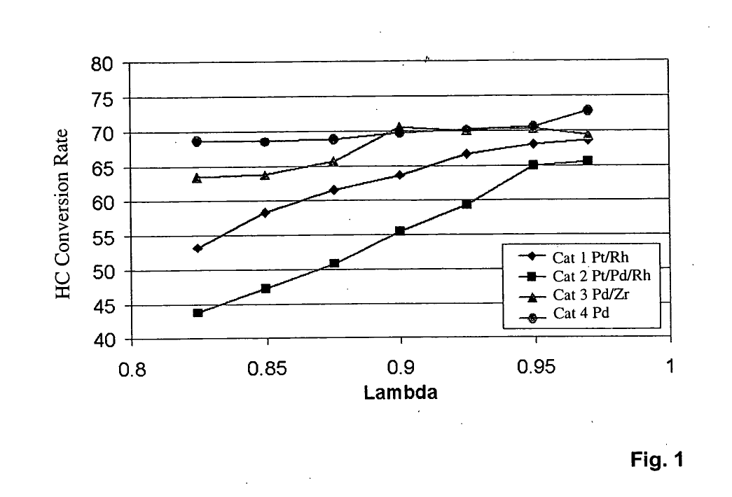

FIG. 1 is a graph of lean-burn operation curves (HC conversion rate vs. lambda value) of a typical stratified scavenging engine using different catalytic-converter concepts, namely:
Catalytic converter 1 (“Cat 1”): typical bimetal, Pt+Rh as active components, with oxygen storage component (comparative example);
Catalytic converter 2 (“Cat 2”): trimetal, Pt+Pd+Rh as active components, with oxygen storage component (comparative example);
Catalytic converter 3 (“Cat 3”): Pd, Zr as dopant, no oxygen storage component (inventive example); and
Catalytic converter 4 (“Cat 4”): Pd, no oxygen storage component (inventive example).

### DETAILED DESCRIPTION OF THE INVENTION

One of each catalytic converter is welded into a muffler of a Komatsu-Zenoah engine, and on an exhaust-gas measurement test stand, the conversion rate is determined at a given lambda value. As a first example, a typical bimetal catalytic converter with platinum and rhodium as active components and an oxygen storage component is tested. In the second example, a trimetal catalytic converter with active components is tested for further comparison. In the third example, a palladium catalytic converter according to the invention, which is doped with zirconium, is tested. In the fourth example, a palladium catalytic converter according to the invention is used. The measurement results are illustrated in FIG. 1.

Clearly, the conversion rate with the catalytic converters 3 and 4 according to the invention is higher relative to the comparative catalytic converters 1 and 2. Here, it can be seen that the comparative catalytic converters 1 and 2 for rich mixtures starting at a lambda of approximately 0.95 fall rapidly in their conversion rate, whereas the conversion rate of catalytic converter 3 falls only slightly and that of catalytic converter 4 remains nearly constant. The range of lambda >0.8 to lambda <0.95 is the typical range of these new two-cycle stratified scavenging engines. Thus, it is shown that the catalytic converters of the prior art cannot exhibit satisfactory results with regard to conversion rate for use with this new engine generation. This problem was solved with the catalytic converters according to the invention.

### Catalytic Converter 1 (Comparative)

A commercially available catalytic converter for small engines, having cerium oxide as the oxygen storage component and a noble-metal coating of 50 g/ft³ having platinum and rhodium as active components, is welded into a muffler for small engines and attached to a conventional Komatsu-Zenoah stratified scavenging engine having 25 cc stroke displacement. The test cycle approved by the Environmental Protection Agency (EPA) was performed, and then the lean-burn operation curve shown in FIG. 1 was plotted. For this purpose, different exhaust-gas compositions (lambda values) are generated by changing carburetor settings at a constant rpm. At each of these points, the hydrocarbon content of the exhaust gas is measured before and after the catalytic converter. This gives the conversion rate, which is recorded in FIG. 1 versus the lambda values.

### Catalytic Converter 2 (Comparative)

In a glass cylinder, 245.6 g of a commercially available, non-stabilized aluminum oxide having a BET of 150 g/m² is suspended in water. Then, 4.4 g of a 5% noble-metal solution, comprising palladium chloride, platinum chloride, and rhodium chloride is added and adsorbed on the aluminum oxide. In another glass cylinder, 245.6 of a commercially available cerium/zirconium mixed oxide having a BET of 110 m²/g is suspended in water. To this, 4.4 g of a 5% noble-metal solution, comprising palladium chloride, platinum chloride, and rhodium chloride is added and adsorbed on the cerium/zirconium mixed oxide. The thus-produced oxide powder is then filtered separately, dried at 150° C., and then calcined at 500° C. in air. The oxide powder impregnated in this way is suspended in water and ethanoic acid and ground in a ball mill. In the thus-produced coating dispersion, a commercially available metal carrier with a 35 mm matrix diameter and a 25 mm matrix length, as well as a cell count of 300 cpsi, is immersed, blown, and dried at 150° C., before being recalcined at 500° C. The thus-produced catalytic converter having a noble-metal coating of 50 g/ft³ with platinum, palladium, and rhodium as active components is welded into a muffler for small engines and attached to a conventional Komatsu-Zenoah stratified scavenging engine having 25 cc stroke displacement. A test cycle approved by the EPA was performed, and then the lean-burn operation curve shown in FIG. 1 was plotted. For this purpose, different exhaust gas compositions (lambda values) are generated by changing carburetor settings at a constant rpm. At each of these points, the hydrocarbon content of the exhaust gas is measured before and after the catalytic converter. This gives the conversion rate, which is recorded in FIG. 1 versus the lambda values.

### Catalytic Converter 3

In a glass cylinder, 491.2 g of a La-stabilized aluminum oxide having a BET of 120 g/m² is suspended in water. Then, 8.8 g of a 10% palladium chloride solution is added and adsorbed on the aluminum oxide. All other steps are carried out analogously to comparative catalytic converter 2 above.

### Catalytic Converter 4

This example is carried out analogously to catalytic converter 3 above, except a noble-metal solution zirconium nitrate is added, so that a weight ratio of Pd to Zr of 1:1 results. All other steps are carried out analogously to catalytic converter 2 above.

The results of the engine tests can be seen in FIG. 1. The HC conversion rates of the described catalytic converters were recorded versus the lambda values. Clear differences in the conversion behavior can be recognized at different lambda values. While the HC conversion rate of the comparative examples (catalytic converter 1 and catalytic converter 2) fall significantly at lambda values <0.9, thus in the rich-mixture range, the catalytic converters according to the invention surprisingly exhibit constant HC conversion rates over the entire lambda range. This can be attributed to the particular composition of the catalytic converters according to the invention.

Starting with the catalytic converter 1 representing the prior art, a degradation of the HC conversion rate can be seen by the addition of palladium according to catalytic converter 2. In contrast, the conversion rates with the catalytic converters 3 and 4, which have no active oxygen storage component, is improved significantly.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A catalytic converter for 2-cycle stratified scavenging engines or engines having a comparable exhaust gas composition, the converter comprising an active phase containing at least one noble metal in a wash coat on a heat-resistant carrier, wherein the portion of an oxygen storage component in the wash coat is less than about 10 wt. %.

2. The catalytic converter according to claim 1, wherein the wash coat is a high temperature-resistant doped aluminum oxide.

3. The catalytic converter according to claim 1, wherein the active phase comprises substantial portions of palladium or mixtures of palladium with other noble metals.

4. The catalytic converter according to claim 3, wherein the active phase comprises rhodium as another essential component in addition to palladium.

5. The catalytic converter according to claim 1, wherein the active phase comprises noble-metal components and zirconium oxide.

6. The catalytic converter according to claim 5, wherein the weight ratio of zirconium oxide to noble-metal components is in a range of about 4:1 to 1:2.

7. A method of cleaning exhaust gas from a 2-cycle stratified scavenging engine, comprising contacting the exhaust gas with a catalytic converter wherein the portion of oxygen storage component in a wash coat of the catalytic converter is less than about 10 wt. %.

8. A method for catalytic exhaust-gas cleaning of rich-mixture exhaust gases, comprising contacting the gases with an exhaust-gas catalytic converter made of high temperature-resistant carrier material and an active phase containing at least one noble metal, wherein the catalytic converter contains less than about 10 wt. % of an oxygen storage component in a wash coat of the converter.
